(19) United States
(12) Patent Application Publication
(10) Pub. No.: US 2012/0270532 A1
(43) Pub. Date: Oct. 25, 2012

(54) MOBILE COMMUNICATION APPARATUS AND WIRELESS COMMUNICATION METHOD

(75) Inventor: Naritoshi SAITO, Kawasaki (JP)

(73) Assignee: FUJITSU TOSHIBA MOBILE COMMUNICATIONS LIMITED, Kawasaki-shi (JP)

(21) Appl. No.: 13/406,637

(22) Filed: Feb. 28, 2012

(30) Foreign Application Priority Data
Apr. 20, 2011 (JP) 2011-093568

(51) Int. Cl. H04W 36/14; H04W 52/02

(52) U.S. Cl. 455/419

(57) ABSTRACT

A wireless communication unit is configured to perform data communication using a first wireless access network and data communication using a second wireless access network having a larger coverage area than a coverage area of the first wireless access network. A control unit is configured to perform a handover from the first wireless access network to the second wireless access network after the data communication using the first wireless access network is finished, and subsequently cause a mobile communication apparatus to enter into standby mode.

### CROSS-REFERENCE TO RELATED APPLICATION

This application is based upon and claims the benefit of priority of the prior Japanese Patent Application No. 2011-093568, filed on Apr. 20, 2011, the entire contents of which are incorporated herein reference.

### FIELD

The embodiments discussed herein are related to mobile communication apparatus and a wireless communication method.

### BACKGROUND

Wireless communications systems such as mobile telephone systems and wireless Local Area Networks (LANs) are currently in wide use. As wireless access networks accessible from mobile communication apparatuses, there are multiple types of wireless access networks using different communication systems, such as a Code Division Multiple Access (CDMA) 2000 1× network, a CDMA2000 Evolution Data Only (EV-DO) network, and a Worldwide Interoperability for Microwave Access (WiMAX) network. The 1× and EV-DO networks use CDMA as a multiple access scheme. The WiMAX network uses Orthogonal Frequency Division Multiple Access (OFDMA) as a multiple access scheme. Some mobile communication apparatuses are capable of handling multiple types of wireless access networks.

A cell search method has been proposed in which, even when a mobile wireless terminal is in standby mode in a mobile telephone system having a lower priority, the mobile wireless terminal immediately performs a cell search to thereby find a cell of a mobile telephone system having a higher priority it a user of the mobile wireless terminal executes an outbound operation such as originating call (see Japanese Laid-open Patent Publication No. 2004-187104, for example). In addition, a search method has been proposed in which, when a dual-mode mobile terminal is in standby mode in an unprioritized system, the dual-mode mobile terminal searches for a prioritized system having a smaller coverage area than the coverage area of the unprioritized system at a timing indicated by information received from the unprioritized system (see Japanese Laid-open Patent Publication No. 2004-187104, for example).

Further, a wireless LAN terminal has been proposed which uses the same Internet Protocol (IP) address continuously before and after a handover in the case when an access point of a handover origin and an access point of a handover destination belong to the same subnet (short for “subnetwork”) (see Japanese Laid-open Patent Publication No. 2008-11184, for example). Also, a handover method has been proposed in which a mobile station performs a handover between a WiMAX network and an EV-DO network while maintaining an IP session (see, for example, Peretz Feder, Ramana Isukapalli and Semyon Mizikovsky, “WiMAX-EVDO interworking Using Mobile IP”, The Institute of Electrical and Electronics Engineers (IEEE) Communications Magazine, pp. 122-131, June 2009).

As described above, there are wireless access networks having large coverage areas, in which mobile communication apparatuses are able to make communication, and there are those having small coverage areas. Some wireless access networks having small coverage areas have an advantage that a communication band between a mobile communication apparatus and a base station is wider compared to the communication band in wireless access networks having large coverage areas. Mobile communication apparatuses capable of handling multiple wireless access networks selectively use an appropriate wireless access network on each occasion, to thereby have the benefit of a wide coverage area as well as other benefits.

However, the mobile communication apparatuses capable of handling multiple wireless access networks leave the problem that the power consumption in standby mode, during which data communication is performed, increases depending on the standby method. For example, in the case when such a mobile communication apparatus enters straight into standby mode after performing data communication using a wireless access network having a small coverage area, it is relatively likely that a handover occurs because the mobile communication apparatus moves outside the coverage of the wireless network having a small coverage area during the standby mode. In this case, the mobile communication apparatus continuous performs, for example, processing for preparing for the occurrence of a handover across wireless access networks, which possibly leads to an increase in the power consumption during standby mode.

### SUMMARY

In one aspect of the embodiments, there is provided a mobile communication apparatus including a wireless communication unit configured to perform data communication using a first wireless access network and data communication using a second wireless access network having a larger coverage area than a coverage area of the first wireless access network; and a control unit configured to perform a handover from the first wireless access network to the second wireless access network after the data communication using the first wireless access network is finished, and subsequently cause the mobile communication apparatus to enter into standby mode.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a mobile communication apparatus according to a first embodiment;

FIG. 2 illustrates a mobile communication system according to a second embodiment;

FIG. 3 illustrates an example of wireless communication coverage areas;

FIG. 4 illustrates examples of physical channels of wireless access networks;

FIG. 5 illustrates an example of physical channels of another wireless access network;

FIGS. 6A, 6B, and 6C illustrate examples of timings of paging information reception;

FIG. 7 is a block diagram illustrating an example of a mobile station;

FIG. 8 is a block diagram illustrating an example of a terminal control unit;

FIG. 9 is a flowchart illustrating a transition to idle mode;

FIG. 10 is a flowchart illustrating a transition to active mode;

FIG. 11 is a sequence diagram illustrating an example of an initial connection to a wireless access network;

FIG. 12 is a sequence diagram illustrating an example of a first handover;

FIG. 13 is a sequence diagram illustrating the example of the first handover, continued from FIG. 12;

FIG. 14 is a sequence diagram illustrating an example of a second handover; and

FIG. 15 is a sequence diagram illustrating the example of the second handover, continued from FIG. 14.

### DESCRIPTION OF EMBODIMENTS

Several embodiments will be described below with reference to the accompanying drawings, wherein like reference numerals refer to like elements throughout.

### [a] First Embodiment

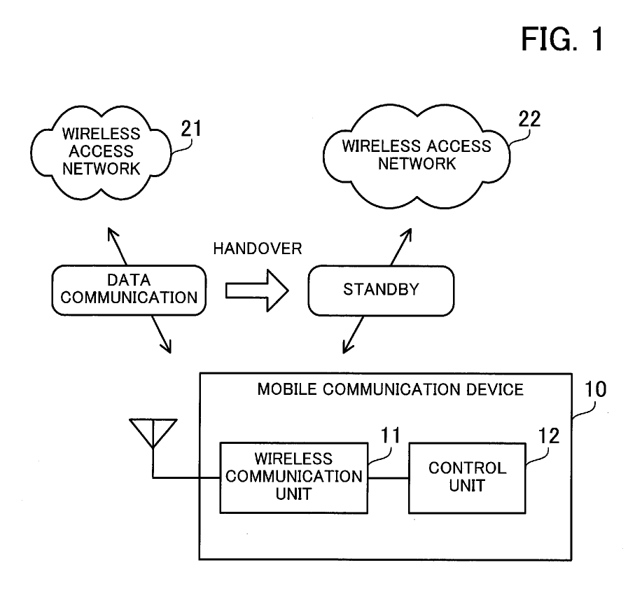

FIG. 1 illustrates a mobile communication device according to a first embodiment. A mobile communication device 10 of the first embodiment performs wireless communication using a wireless access network 21 (first wireless access network) and a wireless access network 22 (second wireless access network). The mobile communication device 10 is a wireless terminal, such as a mobile phone and a handheld terminal. The wireless access network 22 has a larger coverage area than a coverage area of the wireless access network 21. For example, the coverage area of the wireless access network 22 includes that of the wireless network 21. The wireless access networks 21 and 22 may use different communication systems. A case may be considered in which, for example, the wireless access network 21 is a WiMAX network and the wireless access network 22 is a CDMA2000 EV-DO network.

In the coverage area of the wireless access network 21, the mobile communication device 10 is able to perform wireless communication using the wireless access network 21, and in the coverage area of the wireless access network 22, the mobile communication device 10 is able to perform wireless communication using the wireless access network 22. At a site covered by both the wireless access networks 21 and 22, the mobile communication device 10 selects, according to a predetermined standard, a wireless access network to be used. For example, the mobile communication device 10 may preferentially use the wireless network 21. The mobile communication device 10 includes a wireless communication unit 11 and a control unit 12. The wireless communication unit 11 is able to perform data communication using the wireless network 21 and data communication using the wireless access network 22. For example, the wireless communication unit 11 performs data reception processing including demodulation and decoding, and performs data transmission processing including encoding and modulation. In the case where the communication systems of the wireless access networks 21 and 22 are different, the wireless communication unit 11 may include communication subunits individually corresponding to the communication systems. The control unit 12 controls a handover between the wireless access networks 21 and 22 and standby mode (idle mode) of the mobile communication device 10. After the wireless communication unit 11 finishes data communication using the wireless access network 21, the control unit 12 performs a handover from the wireless access network 21 to the wireless access network 22 before causing the mobile communication device 10 to enter into standby mode. With this, the mobile communication device 10 is placed in standby mode in the wireless access network 22 having a large coverage area, rather than being in standby mode in the wireless access network 21 having a smaller coverage area.

During standby mode, the wireless communication unit 11 may stop transmitter circuits corresponding to the wireless access networks 21 and 22. That is, for example, the power supply to the transmitter circuits may be stopped, or the clock frequencies for the transmitter circuits may be reduced. In addition, during the standby mode, the wireless communication unit 11 does not have to search for a base station of the wireless access network 21, and may therefore stop a receiver circuit corresponding to the wireless access network 21. That is, for example, the power supply to the receiver circuit may be stopped, or the clock frequency for the receiver circuit may be reduced. In addition, the wireless communication unit 11 may cause a receiving circuit corresponding to the wireless access network 22 to operate intermittently so as to determine whether paging from the wireless access network 22 is present.

Note that the standby mode is cancelled, for example, when paging from the wireless access network 22 is detected and when transmission data is generated in the mobile communication device 10. Once the standby mode is cancelled, the wireless communication unit 11 may search for a base station of the wireless access network 21. Upon detection of a base station of the wireless access network 21 as a result of the search, the control unit 12 may perform a handover from the wireless access network 22 to the wireless access network 21 so that data communication is performed with the use of the wireless access network 21. In a handover between the wireless access networks 21 and 22, the control unit 12 may carry on the use of an address, which is assigned to the mobile communication device 10 before the handover, after the handover.

The mobile communication device 10 according to the first embodiment performs data communication using the wireless access network 21. After the data communication is finished, a handover is performed from the wireless access network 21 to the wireless access network 22 having a larger coverage area than the coverage area of the wireless access network 21. After the handover to the wireless network 22, the mobile communication device 10 enters into standby mode. From the beginning of the standby mode, the mobile communication device 10 stands by in the wireless access network 22 having a larger coverage area. This reduces the likelihood of the occurrence of a handover across the wireless access networks 21 and 22 during the standby mode. Therefore, the mobile communication device 10 does not have to perform processing to prepare for the occurrence of a handover. Specifically, the mobile communication device 10 does not have to, for example, regularly perform searches in both the wireless access networks 21 and 22. As a result, the power consumption of the mobile communication device 10 during the standby mode is reduced. In addition, the power consumption is further reduced because the mobile communication device 10 need not search for a base station of the wireless access network 21 during the standby mode. In addition, after the standby mode is cancelled, the mobile communication device 10 performs a handover from the wireless access network 22 to the wireless access network 21 to then perform data communication. With this, the mobile communication device 10 is able to preferentially use the wireless access network 21 having a smaller coverage area and thus have the benefits (for example, a wide communication band and high-speed communication) of the wireless access network 21. Further, in the handover between the wireless access networks 21 and 22, the mobile communication 10 carries on the use of the assigned address, thereby being able to continuously receive services from a communication destination of the mobile communication device 10.

A second embodiment described below gives an example in which a mobile communication device performs a handover between a CDMA2000 EV-DO network and a WiMAX network. Note however that the wireless access networks 21 and 22 according to the first embodiment may be other types of wireless access networks. For example, each of the wireless access networks 21 and 22 may be a Wideband Code Division Multiple Access (W-CDMA) network, a Long Term Evolution (LTE) network, a Long Term Evolution Advanced (LTE-A) network, or a wireless LAN network.

### [b] Second Embodiment

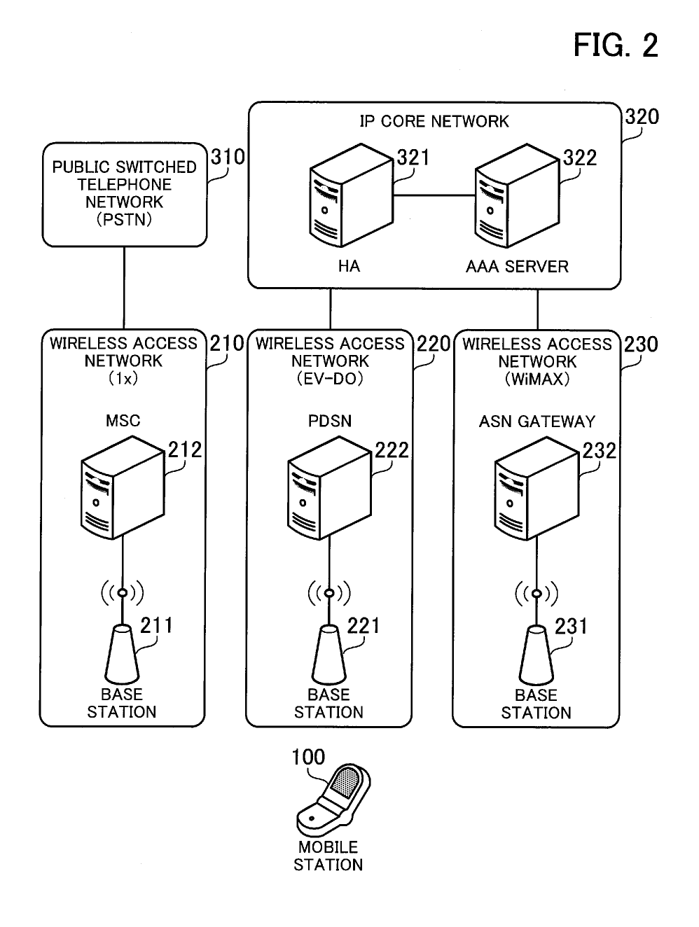

FIG. 2 is a mobile communication system according to the second embodiment. The mobile communication system includes a mobile station 100, wireless access networks 210, 220, and 230, a public switched telephone network (PSTN) 310, and an IP core network 320. Different frequencies, for example, are allocated to the wireless access networks 210, 220, and 230.

The mobile station 100 is a mobile wireless communication device such as a mobile phone and a handheld terminal. The mobile station 100 is capable of performing wireless communication using three communication systems of CDMA2000 1×, CDMA2000 EV-DO, and WiMAX. The mobile station 100 performs voice communication using the 1× system and performs packet communication using the EV-DO system or the WiMAX system.

The wireless access network 210 is a network for performing voice communication with the mobile station 100 using the CDMA2000 1× system. The wireless access network 210 is connected to the PSTN 310. The wireless access network 210 includes multiple base stations, including a base station 211, and a mobile switching center (MSC) 212. Each of the multiple base stations forms a cell, and a collection of cells form a coverage area of the wireless access network 210. In the wireless access network 210, voice signals are transmitted using a circuit switching system. The base station 211 is a communication device for performing wireless communication with the mobile station 100 and performing wired communication with the MSC 212. The base station 211 relays voice signals between the mobile system 100 and the MSC 212. The MSC 212 is a switch for performing wired communication with the base station 211 and the PSTN 310. The MSC 212 establishes connection with the mobile station 100 via the base station 211. The MSC 212, for example, relays voice signals between the base station 211 and the PSTN 310.

The wireless access network 220 is a network for performing packet communication with the mobile station 100 using the CDMA2000 EV-DO system. The wireless access network 220 is connected to the IP core network 320. The wireless access network 220 includes multiple base stations, including a base station 221, and a packet data serving node (PDSN) 222. Each of the multiple base stations forms a cell, and a collection of cells form a coverage area of the wireless access network 220. In the wireless access network 220, packet data is transmitted using a packet switching system. The base station 221 is a communication device for performing wireless communication with the mobile station 100 and performing wired communication with the PDSN 222. The base station 221 relays packet data between the mobile station 100 and the PDSN 222. The PDSN 222 is a gateway for performing wired communication between the base station 221 and the IP core network 320. The PDSN 222 establishes connection with the mobile station 100 via the base station 221. In addition, the PDSN 222 relays packet data between the base station 221 and the IP core network 320.

The wireless access network 230 is a network for performing packet communication with the mobile station 100 using the WiMAX system. The wireless access network 230 is connected to the IP core network 320. The wireless access network 230 includes multiple base stations, including a base station 231, and an access service network (ASN) gateway 232. Each of the multiple base stations forms a cell, and a collection of cells form a coverage area of the wireless access network 230. In the wireless access network 230, packet data is transmitted using a packet switching system. The base station 231 is a communication device for performing wireless communication with the mobile station 100 and performing wired communication with the ASN gateway 232. The base station 231 relays packet data between the mobile station 100 and the ASN gateway 232. The ASN gateway 232 is a gateway for performing wired communication with the base station 231 and the IP core network 320. The ASN gateway 232 establishes connection with the mobile station 100 via the base station 231. In addition, the ASN gateway 232 relays packet data between the base station 231 and the IP core network 320.

The PSTN 310 is a subscriber line network for transmitting voice signals using a circuit switching system. The PSTN 310 is accessed also by land line.

The IP core network 320 is an IP network for controlling packet communication of the mobile station 100 and transmitting packet data using a packet switching system. The IP core network 320 is connected to the wireless access networks 220 and 230. The IP core network 320 includes a home agent (HA) 321 and an authentication, authorization and accounting (AAA) server 322. The HA 321 is a communication device for registering the mobile station 100 connected to the wireless access network 220 or 230 and relaying packet data for the mobile station 100. The HA 321 assigns, to the mobile station 100, a home address (HoA) as an IP address which is independent of a wireless access network to be used. In addition, the HA 321 relays packet data, for which an HoA is specified, between the PDSN 222 or the ASN gateway 232 and a communication destination of the mobile station 100. The AAA server 322 is a server for performing authentication of the mobile station 100 and charging to a user of the mobile station 100. The AAA server 322 authenticates the mobile station 100, for example, when the mobile station 100 accesses the wireless access network 220 or 230. In this manner, the HA 321 and the AAA server 322 are used commonly for both packet communication using the wireless access network 220 and packet communication using the wireless access network 230. The use of the HA 321 and the AAA server 322 enables maintenance of the IP address continuity) assigned to the mobile station 100 even if the mobile station 100 performs a handover between the wireless access networks 220 and 230. The maintenance of the IP address allows the communication destination of the mobile station 100 to continue its service when the mobile station 100 performs a handover across the wireless access networks 220 and 230.

Note that the mobile station 100 is one example of the mobile communication device 10 of the first embodiment. The wireless access network 230 is one example of the wireless access network 21 of the first embodiment. The wireless access network 220 is one example of the wireless access network 22 of the first embodiment. In addition, although the different base stations 211 and 221 are provided for individually performing voice communication and packet communication in FIG. 2, a single base station may be provided for performing both voice and packet communications. In such a case, the single base station performs voice communication with the mobile station 100 using the MSC 212 and performs packet communication with the mobile station 100 using the PDSN 222.

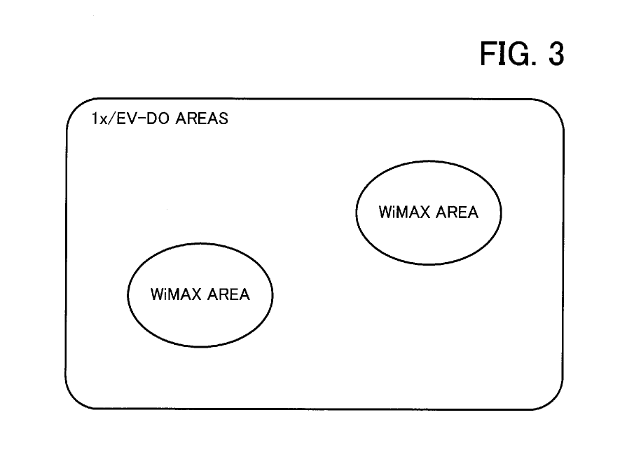

FIG. 3 illustrates an example of wireless communication coverage areas. For example, a coverage area in which the wireless access network 210 provides voice communication using the 1× system and a coverage area in which the wireless access network 220 provides packet communication using the EV-DO system coincide with each other, or overlap each other in large part. On the other hand, a coverage area in which the wireless access network 230 provides packet communication using the WiMAX system is smaller than the coverage areas of the wireless access networks 210 and 220 and overlaps a part of the coverage areas of the wireless access networks 210 and 220. For example, the coverage area of the wireless access network 230 may occur in places within the coverage areas of the wireless access networks 210 and 220. Note that the wireless access network 230 is capable of performing faster packet communication in a wider bandwidth compared to the wireless access network 220. Accordingly, it is preferable that the mobile station 100 preferentially use the wireless access network 230 when being in the coverage area of the wireless access network 230.

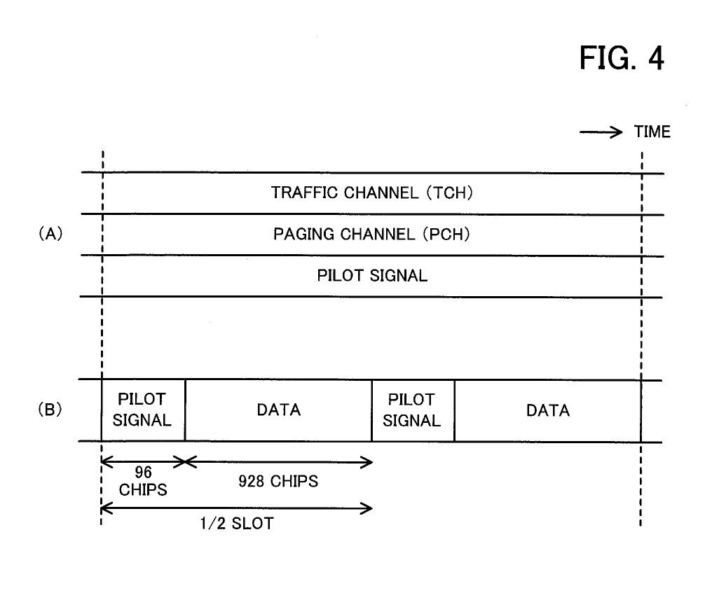

FIG. 4 illustrates examples of physical channels of wireless access networks. FIG. 4(A) illustrates example of 1× system physical channels transmitted by the base station 211 of the wireless access network 210, and FIG. 4(B) illustrates an example of an EV-DO system physical channel transmitted by the base station 221 of the wireless access network 220. The base station 211 transmits a traffic channel (TCH) signal, a paging channel (PCH) signal and a known pilot signal in different frequencies. The TCH signal includes a voice signal, and the PCH signal includes paging information indicating whether there is an incoming call to the mobile station 100. During standby mode, the mobile station 100 intermittently receives such paging information from the base station 211 to determine whether there is a voice incoming call. In addition, when connecting to the wireless access network 210, the mobile station 100 receives the pilot signal so as to be synchronized with the base station 211. The base station 221 transmits data and a known pilot signal in the same frequency by a time division method. Of a one-half slot (1024 chips), 928 chips are allocated to the data and 96 chips are allocated to the pilot signal. The data includes paging information indicating whether there is an incoming call to the mobile station 100. During standby mode, the mobile station 100 intermittently receives such paging information from the base station 221 to determine whether there is an incoming call. In addition, when connecting to the wireless access network 220, the mobile station 100 receives the pilot signal so as to be synchronized with the base station 221.

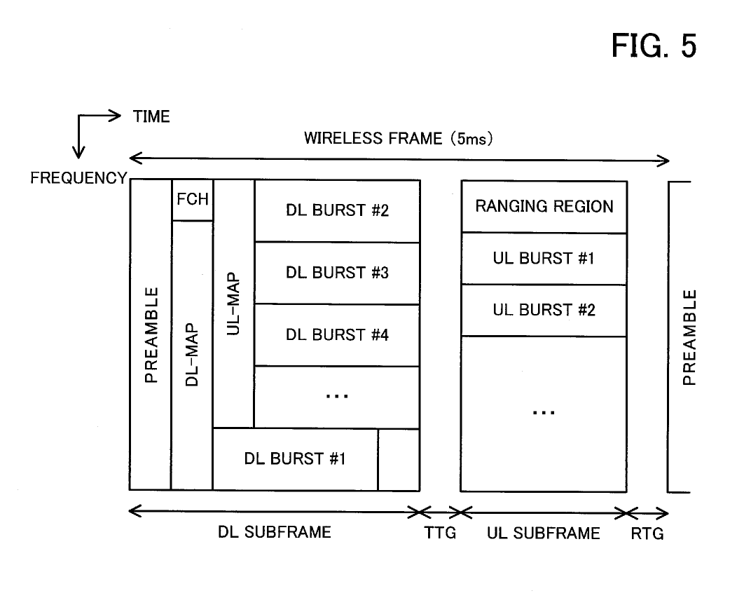

FIG. 5 illustrates an example of physical channels of another wireless access network. FIG. 5 illustrates an example of WiMAX system wireless frames handled by the base station 231 of the wireless access network 230. In OFDMA, wireless resources are subdivided in a frequency direction and a time direction, and the individual subdivisions are allocated to various physical channel signals. A five-millisecond wireless frame includes a downlink (DL) subframe and uplink (UP) subframe. Between the DL subframe and the UL subframe, an interval called a transmit transition gap (TTG) is inserted. Between the UL subframe and a DL subframe of the next wireless frame, an interval called a receive transition gap (RTG) is inserted. The DL subframe transmitted by the base station 231 includes a preamble, a frame control header (FCH), a DL-MAP, an UL-MAP, and DL bursts. The UL subframe transmitted by the mobile station 100 includes a ranging region and UL bursts. The preamble is a known pilot signal. The FCH includes information with which the mobile station 100 is able to identify MAP regions. The DL-MAP is control information indicating allocation of wireless resources to the DL bursts. Note that the UL-MAP is treated as a part of the DL bursts. The UL-MAP is control information indicating allocation of the wireless resources to the UL bursts. Note that the ranging region is treated as a part of the UL bursts. The DL bursts may include packet data and paging information. In addition, the DL bursts may include an uplink channel descriptor (UCD). The UCD indicates physical parameters of the UL subframe, such as a modulation encoding scheme to be used in the UL bursts. With the ranging region, the mobile station 100 is able to transmit, to the base station 231, a ranging code which is a predetermined signal sequence. By detecting the ranging code, the base station 231 recognizes the presence of a mobile station requesting access to the base station 231. With the UL bursts, the mobile station 100 is able to transmit packet data to the base station 231. When connecting to the wireless access network 230, the mobile station 100 receives the preamble so as to be synchronized with the base station 231, and then transmits, to the base station 231, the ranging code in the ranging region. In addition, during standby mode, the mobile station 100 intermittently receives paging information from the base station 231 to determine whether there is an incoming call.

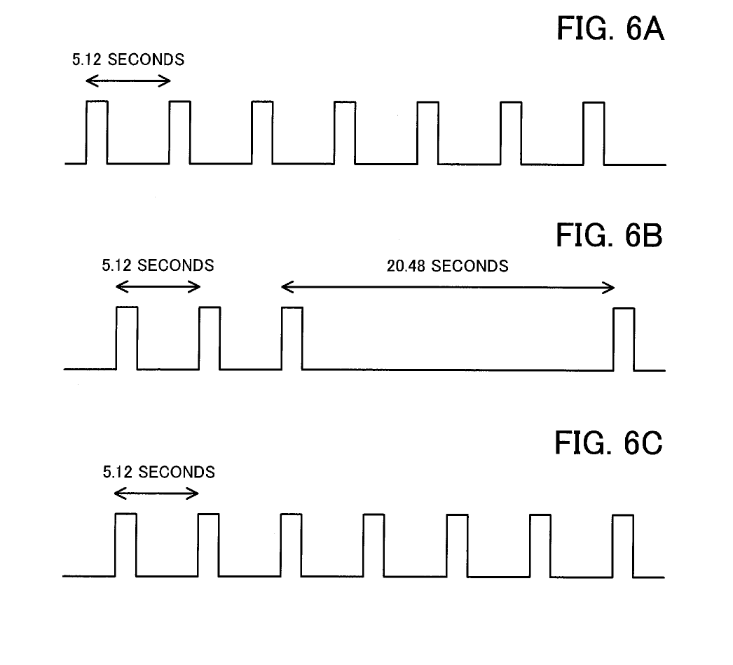

FIGS. 6A, 6B, and 6C illustrate examples of timings of paging information reception. With respect to voice communication, the mobile station 100 intermittently receives paging information from the base station 211 during idle mode (standby mode). With respect to packet communication, the mobile station 100 intermittently receives paging information from the base station 221 during idle mode in the EV-DO system, and intermittently receives paging information from the base station 231 during idle mode in the WiMAX system. For example, during idle mode, the mobile station 100 receives paging information from the base station 211 every 5.12 seconds (FIG. 6A). During idle mode in the EV-DO system, the mobile station 100 receives paging information from the base station 221 every 5.12 seconds (FIG. 6B). Note however that, when fifteen minutes have elapsed since a transition to the idle mode, the mobile station 100 may receive paging information from the base station 221 every 20.48 seconds. The base stations 211 and 221 make adjustments so that the timing of the 1× system paging and the timing of the EV-DO system paging are different. During idle mode in the WiMAX system, the mobile station 100 receives paging information from the base station 231 every 5.12 seconds (FIG. 6C). The timing of the WiMAX system paging may overlap with the timing of the 1× system paging or the EV-DO system paging. In such a case, the mobile station 100 performs reception processes of the multiple communication systems at the overlapped timing. Note however that, in principle, the mobile station 100 enters into not the idle mode in WiMAX system but idle mode in the EV-DO system after packet communication is finished, as described later.

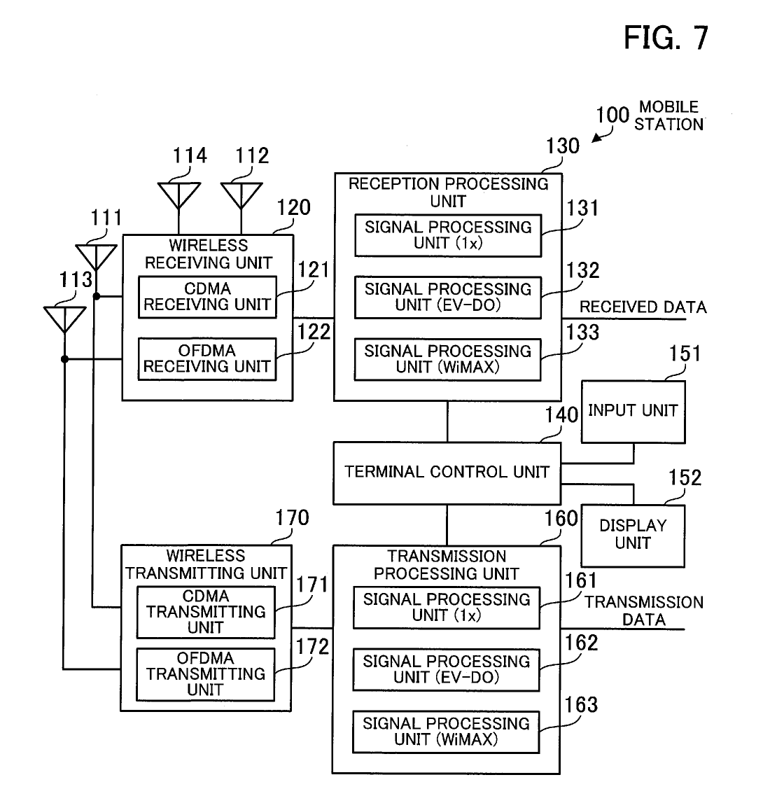

FIG. 7 is a block diagram illustrating an example of the mobile station. The mobile station 100 includes antennas 111, 112, 113, and 114, a wireless receiving unit 120, a reception processing unit 130, a terminal control unit 140, an input unit 151, a display unit 152, a transmission processing unit 160, and a wireless transmitting unit 170.

The antennas 111 and 113 are used for both transmission and reception. The antennas 112 and 114 are used for reception. The antennas 111 and 112 receive wireless signals from the wireless access networks 210 and 220. In addition, the antenna 111 transmits wireless signals to the wireless access networks 210 and 220. The antennas 113 and 114 receive wireless signals from the wireless access network 230. In addition, the antenna 113 transmits wireless signals to the wireless access network 230.

The wireless receiving unit 120 down-converts a received high-frequency wireless signal to a baseband signal and outputs the baseband signal to the reception processing unit 130. The wireless receiving unit 120 includes a CDMA receiving unit 121 and an OFDMA receiving unit 122. The CDMA receiving unit 121 processes 1× system and EV-DO system wireless signals received by the antennas 111 and 112. Using the antennas 111 and 112, diversity communication and multiple input multiple output (MIMO) communication may be carried out. The OFDMA receiving unit 122 processes WiMAX system wireless signals received by the antennas 11.3 and 114. Using the antennas 113 and 114, diversity communication and MIMO communication may be carried out.

The reception processing unit 130 acquires a baseband signal from the wireless receiving unit 120 and performs baseband processing which includes demodulation and error correction decoding, to thereby extract a voice signal or packet data, and control information. The reception processing unit 130 includes signal processing units 131, 132, and 133. The signal processing unit 131 acquires a baseband signal from the CDMA receiving unit 121 and performs 1× system baseband processing to thereby extract a voice signal and the like. The signal processing unit 132 acquires a baseband signal from the CDMA receiving unit 121 and performs EV-DO system baseband processing to thereby extract packet data and the like. The baseband processing performed by the signal processing units 131 and 132 includes back-diffusion demodulation. The signal processing unit 133 acquires a baseband signal from the OFDMA receiving unit 122 and performs WiMAX system baseband processing to thereby extract packet data and the like. The baseband processing performed by the signal processing unit 133 includes fast Fourier transform (FFT).

The terminal control unit 140 controls wireless communication performed by the wireless receiving unit 120, the reception processing unit 130, the transmission processing unit 160, and the wireless transmitting unit 170. For example, the terminal control unit 140 controls searches for the base stations 211, 221, and 231, voice communication and packet communication, handovers, switching between active mode and idle mode, and the like. In addition, the terminal control unit 140 also controls a user interface implemented by the input unit 151 and the display unit 152. The terminal control unit 140 may be implemented by a central processing unit (CPU) and a random access memory (RAM).

The input unit 151 is an input device for receiving a user operation. As the input unit 151, a key pad which detects pressing of keys or a touch and which detects a touched position, for example, may be used. The display unit 152 is used to display images. As the display unit 152, a liquid crystal display (LCD) or an organic electro-luminescence (EL) display, for example, may be used.

The transmission processing unit 160 acquires a voice signal and packet data generated in the mobile station 100 and performs error correction encoding and modulation to thereby generate a baseband signal to be transmitted as a transmission signal. The transmission processing unit 160 includes signal processing units 161, 162, and 163. The signal processing unit 161 acquires a voice signal and the like to perform 1× system baseband processing. The signal processing unit 162 acquires packet data and the like to perform EV-DO system baseband processing. The baseband processing performed by the signal processing units 161 and 162 includes diffusion modulation. The signal processing unit 163 acquires packet data and the like to perform WiMAX system baseband processing. The baseband processing performed by the signal processing unit 163 includes inverse fast Fourier transform (IFFT).

The wireless transmitting unit 170 up-converts a baseband signal acquired from the transmission processing unit 160 to a high-frequency wireless signal, and outputs the wireless signal to the antennas 111 and 113. The wireless transmitting unit 170 includes a CDMA transmitting unit 171 and an OFDMA transmitting unit 172. The CDMA transmitting unit 171 processes a 1× system baseband signal acquired from the signal processing unit 161 to generate a wireless signal, and outputs the wireless signal to the antenna 111. In addition, the CDMA transmitting unit 171 processes an EV-DO system baseband signal acquired from the signal processing unit 162 to generate a wireless signal, and outputs the wireless signal to the antenna 111. The OFDMA transmitting unit 172 processes a WiMAX system baseband signal acquired from the signal processing unit 163 to generate a wireless signal, and outputs the wireless signal to the antenna 113.

During idle mode, the mobile station 100 may stop the transmission processing unit 160 and the wireless transmitting unit 170. In addition, for packet communication, the mobile station 100 enters into not idle mode in the WiMAX system but idle mode in the EV-DO system, as described later. Therefore, the mobile station 100 may stop the OFDMA receiving unit 122 and the signal processing unit 133. Further, during the idle mode, the mobile station 100 causes the CDMA receiving unit 121 and the signal processing units 131 and 132 to intermittently operate at individual timings of paging information reception, and stops the CDMA receiving unit 121 and the signal processing units 131 and 132 for the rest of the time. Note here that the stop processing may include a process of stopping the power supply, reducing the clock frequency, or the like. Note that a unit formed by integrating the wireless receiving unit 120, the reception processing unit 130, the transmission processing unit 160, and the wireless transmitting unit 170 is an example of the wireless communication unit 11 of the first embodiment. The terminal control unit 140 is an example of the control unit 12 of the first embodiment.

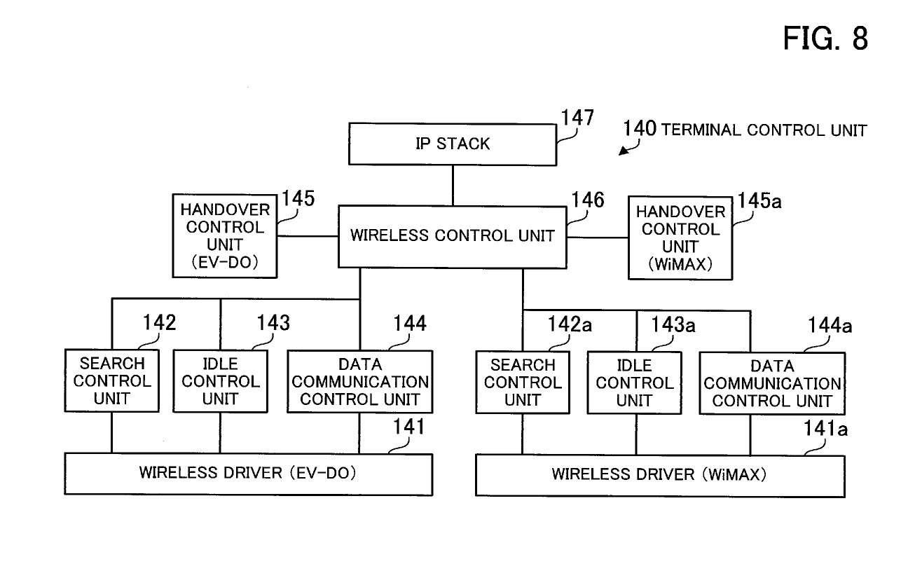

FIG. 8 is a block diagram illustrating an example of the terminal control unit. The terminal control unit 140 includes wireless drivers 141 and 141a, search control units 142 and 142a, idle control units 143 and 143a, data communication control units 144 and 144a, handover control units 145 and 145a, a wireless control unit 146, and an IP stack 147. Note that FIG. 8 illustrates only blocks for packet communication using the wireless access networks 220 and 230 and omits other blocks (for example, blocks for voice communication using the wireless access network 210).

The wireless driver 141 is provided for packet communication in the EV-DO system and controls signal processing performed by the signal processing units 132 and 162. The wireless driver 141a is provided for packet communication in the WiMAX system and controls signal processing performed by the signal processing units 133 and 163.

The search control unit 142 instructs the signal processing unit 132 via the wireless driver 141 to search a base station of the wireless access network 220. Similarly, the search control unit 142a instructs the signal processing unit 133 is the wireless driver 141a to search for a base station of the wireless access network 230.

The idle control unit 143 detects start and end of packet communication in the EV-DO system, and instructs the signal processing units 132 and 162 via the wireless driver 141 to switch between active mode and idle mode. Similarly, the idle control unit 143a detects start and end of packet communication in the WiMAX system, and instructs the signal processing units 133 and 163 via the wireless driver 141a to switch between active mode and idle mode.

The data communication control unit 144 controls packet communication in the EV-DO system. Similarly, the data communication control unit 144a controls packet communication in the WiMAX system.

The handover control unit 145 controls a handover between base stations of the wireless access network 220 and a handover from a base station (the base station 231, for example) of the wireless access network 230 to a base station (the base station 221, for example) of wireless access network 220. Similarly, the handover control unit 145a controls a handover between base stations of the wireless access network 230 and a handover from a base station of the wireless access network 220 to a base station of the wireless access network 230.

The wireless control unit 146 has overall control of connections to the wireless access networks 220 and 230, handovers, switching between active mode and idle mode, and the like. For a handover across the wireless access networks 220 and 230, the wireless control unit 146 makes control in such a manner as to realize IP continuity. That is, the wireless control unit 146 enables a HoA assigned by the HA 321 before the handover to be continuously used after the handover.

The IP stack 147 stores an IP address which is the HoA assigned by HA 321. At the time of a handover from the wireless access network 230 to the wireless access network 220, the IP address stored in the IP stack 147 is provided to the handover control unit 145 by the wireless control unit 146. Similarly, at the time of a handover from the wireless access network 220 to the wireless access network 230, the IP address stored in the IP stack 147 is provided to the handover control unit 145a by the wireless control unit 146.

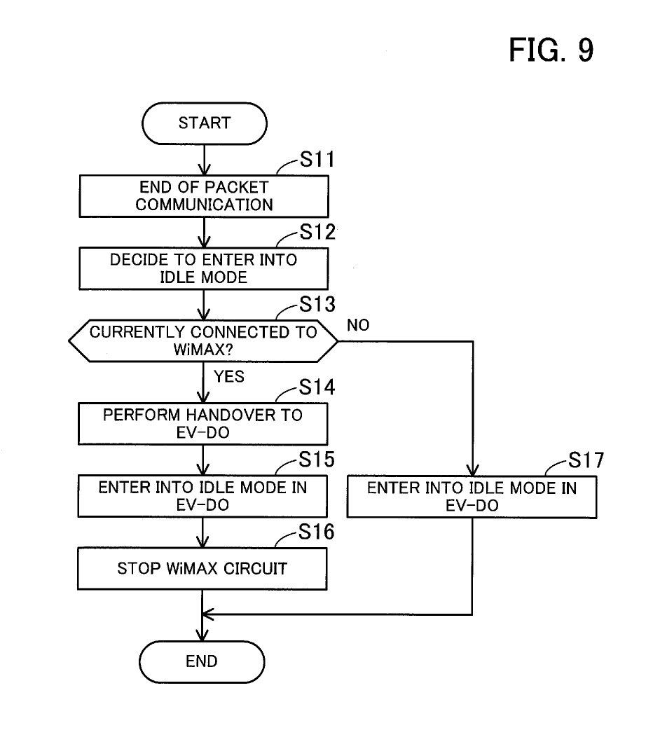

FIG. 9 is a flowchart illustrating a transition to idle mode. Next described is the process illustrated in FIG. 9 according to the step numbers.

(Step S11) The terminal control unit 140 detects end of packet communication in the wireless access network 220 (EV-DO system) or the wireless access network 230 (WiMAX system).

(Step S12) In the case of determining that there is no occurrence of other voice communication or packet communication, the terminal control unit 140 decides to cause the mobile station 100 to enter into idle mode from active mode.

(Step S13) The terminal control unit 140 determines whether, of the wireless access networks 220 and 230, the mobile station 100 is currently connected to the wireless access network 230 (WiMAX system) for packet communication. In the case where the mobile station 100 is currently connected to the wireless access network 230, the process proceeds to Step S14. In the case where the mobile station 100 is currently connected to the wireless access network 220 (EV-DO system), the process proceeds to Step S17.

(Step S14) The terminal control unit 140 controls the signal processing units 132, 133, 162, and 163 to thereby perform a handover from the base station 231 of the wireless access network 230 to the base station 221 of the wireless access network 220. Assume here that the handover is a make-before-break handover (MBBHO) which establishes connection to the base station 221 before terminating connection to the base station 231. At the time of the handover, the terminal control unit 140 carries on the use of the HoA assigned to the mobile station 100. The procedure of the handover with IP continuity is described later.

(Step S15) The terminal control unit 140 controls the signal processing units 132 and 162 to thereby cause the mobile station 100 to enter into idle mode in the wireless access network 220 (EV-DO system).

(Step S16) The terminal control unit 140 stops signal processing of the transmission processing unit 160 and the wireless transmitting unit 170. In addition, the terminal control unit 140 stops signal processing of the OFDMA receiving unit 122 and the signal processing unit 133 (i.e., a circuit for performing WiMAX signal processing). Further, the terminal control unit 140 causes the CDMA receiving unit 121 and the signal processing units 131 and 132 to intermittently operate in accordance with the timing of paging.

(Step S17) The terminal control unit 140 controls the signal processing units 132 and 162 to thereby cause the mobile station 100 to enter into idle mode in the wireless access network 220 (EV-DO system). The terminal control unit 140 stops signal processing of the transmission processing unit 160 and the wireless transmitting unit 170. In addition, the terminal control unit 140 causes the CDMA receiving unit 121 and the signal processing units 131 and 132 to intermittently operate.

With this, the mobile station 100 does not perform a search for the base station 231 of the wireless access network 230 (WiMAX system) during idle mode. In addition, during the idle mode, the mobile station 100 intermittently receives paging information from the base station 211 of the wireless access network 210 (1× system) and the base station 221 of the wireless access network 220 (EV-DO system).

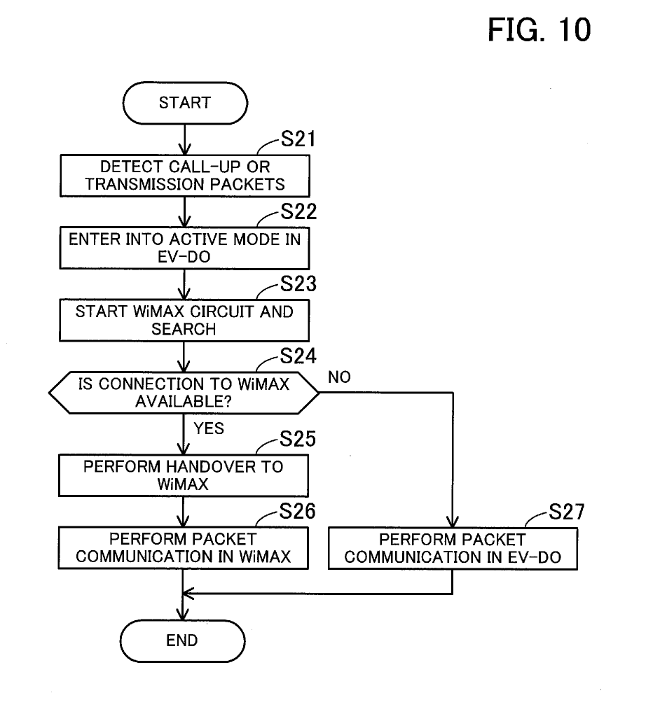

FIG. 10 is a flowchart illustrating a transition to active mode. Next described is the process illustrated in FIG. 10 according to the step numbers.

(Step S21) During idle mode, the terminal control unit 140 detects a trigger for returning to active mode to perform packet communication. The trigger for packet communication may be reception of paging information which indicates a call-up to the mobile station 100 from the base station 221 of the wireless access network 220, or the occurrence of packet data to be transmitted in the mobile station 100.

(Step S22) The terminal control unit 140 controls the signal processing units 132 and 162 to thereby cause the mobile station 100 to enter into active mode in the wireless access network 220 (EV-DO system).

(Step S23) The terminal control unit 140 restarts signal processing of the OFDMA receiving unit 122 and the signal processing unit 133. The signal processing unit 133 performs a search for the base station 231 of the wireless access network 230 (WiMAX system) based on pilot signal (such as a preamble).

(Step S24) Based on the result of the search of the signal processing unit 133, the terminal control unit 140 determines whether it is possible to make connection to the base station 231 of the wireless access network 230 (WiMAX system). For example, in the case where the reception level of a wireless signal transmitted from the base station 231 exceeds a predetermined threshold, the terminal control unit 140 determines that the connection is available. In the case where the connection is available, the process proceeds to Step S25. In the case where the connection is not available, the process proceeds to Step S27.

(Step S25) The terminal control unit 140 controls the signal processing units 132, 133, 162, and 163 to thereby perform a handover from the base station 221 of the wireless access network 220 to the base station 231 of the wireless access network 230. Assume here that the handover is an MBBHO which establishes connection to the base station 231 before terminating connection to the base station 221. At the time of the handover, the terminal control unit 140 carries on the use of the HoA assigned to the mobile station 100.

(Step S26) The terminal control unit 140 decides to perform packet communication using the wireless access network 230 (WiMAX system). The OFDMA receiving unit 122, the signal processing units 133 and 163, and the OFDMA transmitting unit 172 perform packet communication with the base station 231.

(Step S27) The terminal control unit 140 decides to perform packet communication using the wireless access network 220 (EV-DO system). The CDMA receiving unit 121, the signal processing units 132 and 162, and the CDMA transmitting unit 171 perform packet communication with the base station 221.

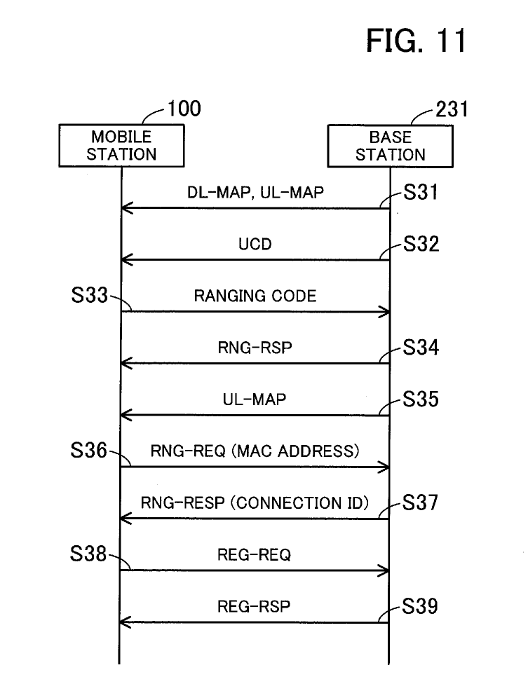

FIG. 11 is a sequence diagram illustrating an example of an initial connection to a wireless access network. FIG. 11 illustrates a procedure performed between the mobile station 100 and the base station 231 of the wireless access network 230 when the mobile station 100 accesses the base station 231 using the WiMAX system.

(Step S31) The base station 231 transmits, in a wireless frame, a DL-MAP and an UL-MAP which indicate allocation of wireless resources. The mobile station 100 receives the DL-MAP from the base station 231 and determines the location of the UL-MAP, and then receives the UL-MAP.

(Step S32) In DL bursts of the wireless frame, the base station 231 transmits a UCD which indicates physical parameters (such as a modulation encoding scheme to be used) of a UL subframe. The mobile station 100 receives the UCD by referring to the DL-MAP.

(Step S33) By referring to the UL-MAP and the UCD received, from the base station 231, the mobile station 100 determines the position of a ranging region and a ranging code to be used. Then, the mobile station 100 transmits the ranging code in the ranging region.

(Step S34) When detecting the ranging code, the base station 231 transmits a ranging response (RNG-RSP) message within a cell of the base station 231. Note that, at this point, the base station 231 does not recognize that the transmission source of the ranging code is the mobile station 100.

(Step S35) The base station 231 allocates wireless resources of UL bursts to the transmission source of the ranging code. Then, the base station 231 transmits an UL-MAP to which the result of the allocation is reflected.

(Step S36) On receiving the RNG-RSP message from the base station 231, the mobile station 100 refers to the UL-MAP to thereby verify the wireless resources of UL bursts allocated to the mobile station 100. Then, using the wireless resources, the mobile station 100 transmits a ranging request (RNG-REQ) message to the base station 231. The RNG-REQ message includes a medium access control (MAC) address for identifying the mobile station 100.

(Step S37) The base station 231 receives the RNG-REQ message and thereby recognizes the mobile station 100, and then attaches a connection ID for identifying a connection. Subsequently, the base station 231 transmits a RNG-RSP message including the connection ID.

(Step S38) On receiving the RNG-RSP message from the base station 231, the mobile station 100 transmits a registration request (REG-REQ) message to the base station 231. The REG-REQ message includes information indicating communications capacity of the mobile station 100.

(Step S39) On receiving the REG-REQ message from the mobile station 100, the base station 231 determines operation mode of the wireless communication between the mobile station 100 and the base station 231 based on the communications capacity of the mobile station 100 and the communication capacity of the base station 231. Then, the base station 231 transmits, to the mobile station 100, a registration response (REG-RSP) message including information of the determined operation mode.

Next described is a procedure of a handover with an IP address maintained. First, a handover from the wireless access network 230 using the WiMAX system to the wireless access network 220 using the EV-DO system is described, which is followed by description of a handover from the wireless network 220 to the wireless access network 230. Note that an example of a handover between the EV-DO network and the WiMAX network is also described in the aforementioned document (Peretz Feder, Ramana Isukapalli and Semyon Mizikovsky, “WiMAX-EVDO Interworking Using Mobile IP”).

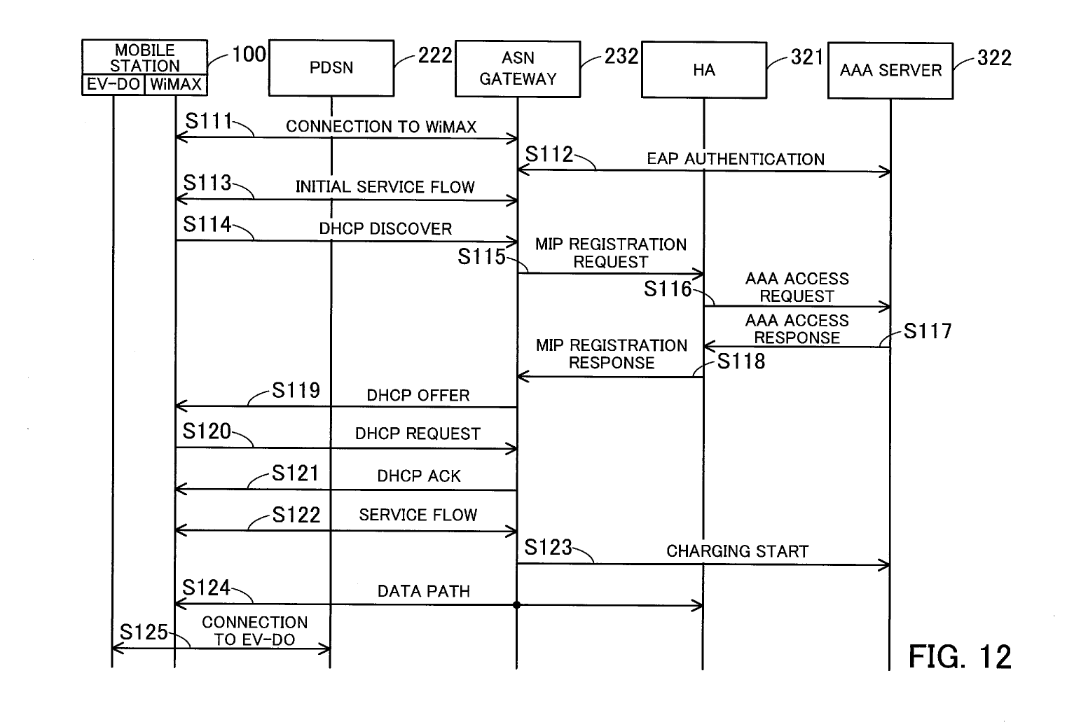

FIG. 12 is a sequence diagram illustrating an example of a first handover.

(Step S111) The mobile station 100 communicates with the ASN gateway 232 via the base station 231 thereby make connection to the wireless access network 230. The procedure described with reference to FIG. 11 is performed between the mobile station 100 and the base station 231.

(Step S112) The ASN gateway 232 requests the AAA server 322 to authenticate the mobile station 100. The AAA server 322 authenticates the mobile station 100 using an extensible authentication protocol (EAP). In the EAP authentication, a network address identifier (NAI), for example, is used as the identifier of the mobile station 100. In the case where the authentication of the mobile station 100 is successful, the AAA server 322 designates the HA 321 as a home agent for relaying packet data of the mobile station 100.

(Step S113) The ASN gateway 232 establishes an initial service flow with the mobile station 100 is the base station 231.

(Step S114) In order to acquire configuration information for communication using a Dynamic Host Configuration Protocol (DHCP), the mobile station 100 transmits a DHCP DISCOVER message to the ASN gateway 232.

(Step S115) The ASN gateway 232 transmits a Mobile Internet Protocol (MIP) registration request to the HA 321 designated by the AAA server 322.

The ASN gateway 232 functions as a Proxy Mobile Internet Protocol (PMIP) client. The MIP registration request includes a PMIP access-technology type extension which is information indicating that the mobile station 100 is present in the WiMAX network.

(Step S116) The HA 321 detects that the mobile station 100 is unregistered. Then, the HA 321 requests a Mobile Node-Home Agent (MN-HA) key, which validates the MIP registration request, from the AAA server 322.

(Step S117) The AAA server 322 transmits the MN-HA key to the HA 321. The HA 321 validates the MIP registration request using the MN-HA key received from the AAA server 322.

(Step S118) The HA 321 assigns, to the mobile station 100, an IP address to be used as a HoA of the mobile station 100 and registers the mobile station 100. Then, the HA 321 transmits a MIP registration response to the ASN gateway 232.

(Step 3119) The ASN gateway 232 transmits a DHCP OFFER message, which includes the IP address assigned by the HA 321, to the mobile station 100 via the base station 231.

(Step S120) The mobile station 100 determines whether there is a problem with configuration information presented in the DHCP OFFER message of the ASN gateway 232. When there is no problem, the mobile station 100 transmits a DHCP REQUEST message to the ASN gateway 232.

(Step S121) The ASN gateway 232 decides to officially apply the configuration information (including the IP address of the mobile station 100) presented in the DHCP OFFER message to the mobile station 100. Then, the ASN gateway 232 transmits a DHCP ACK message to the mobile station 100.

(Step S122) The ASN gateway 232 establishes a service flow with the mobile station 100 via the base station 231.

(Step S123) The ASN gateway 232 instructs the AAA server 322 to start charging for the mobile station 100 to use the wireless access network 230.

(Step S124) A data path is established between the mobile station 100 and the HA 321 via the ASN gateway 232. With this, packet data of the mobile station 100 is transmitted through the data path.

(Step S125) The mobile station 100 decides to perform a handover from the wireless access network 230 (WiMAX system) to the wireless access network 220 (EV-DO system). Subsequently, mobile station 100 is synchronized with the base station 221 and establishes connection with the PDSN 222 via the base station 221. For the connection establishment, a method specified in the 3^{rd} Generation Partnership Project 2 (3GPP2) A-S008-A is, for example, used.

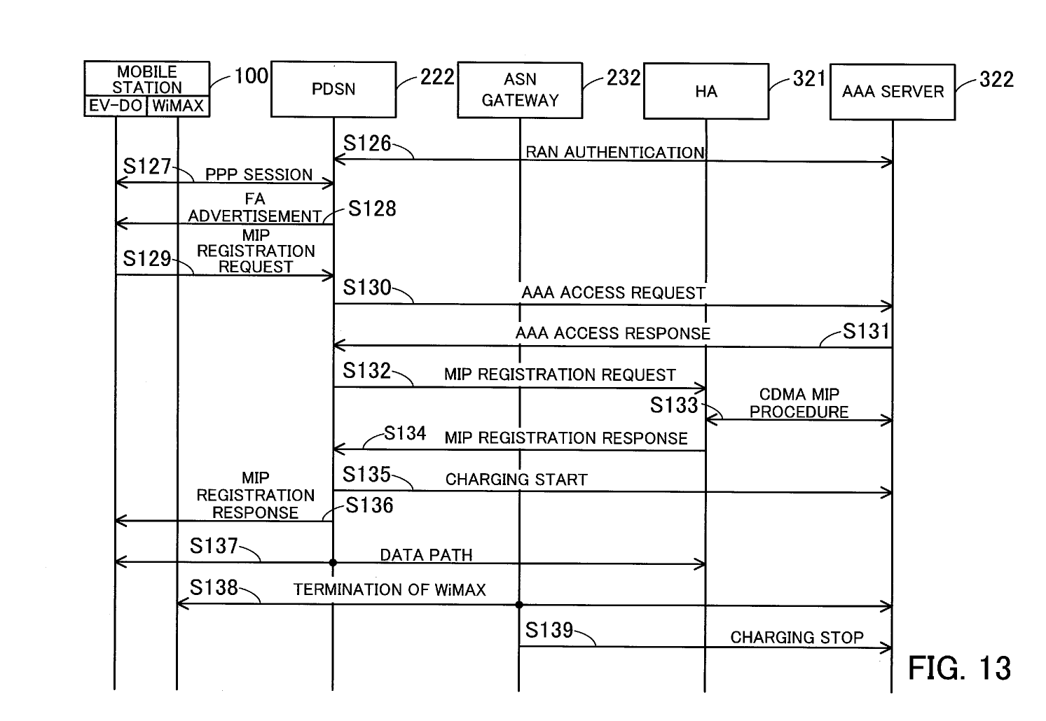

FIG. 13 is a sequence diagram illustrating the example of the first handover, continued from FIG. 12.

(Step S126) The PDSN 222 requests the AAA server 322 to authenticate the mobile station 100. Subsequently, the AAA server 322 performs Radio Access Network (RAN) authentication.

(Step S127) The mobile station 100 establishes a Point-to-Point Protocol (PPP) session with the PDSN 222 using PPP negotiation.

(Step S128) The PDSN 222 transmits a MIP message called a Frequency Assignment (FA) advertisement message to the mobile station 100 via the base station 221.

(Step S129) The mobile station 100 transmits a MIP registration request to the PDSN 222 via the base station 221. In the MIP registration request, the HoA assigned to the mobile station 100 is included. Alternatively, in place of the HoA, a bit sequence whose whole bit length is 0 or 1 is inserted into the MIP registration request.

(Step S130) The PDSN 222 accesses the AAA server 322. The AAA server 322 determines whether a home agent has already been designated to the mobile station 100. In this case, the HA 321 has been designated to the mobile station 100.

(Step S131) The AAA server 322 transmits, to the PDSN 222, an access response including information of the HA 321, which already been designated to the mobile station 100.

(Step S132) The PDSN 222 transmits a MIP registration request to the HA 321 designated by the AAA server 322. Since the mobile station 100 is present in the EV-DO network, the MIP registration request does not include the PMIP access-technology type extension, which is information indicating that the mobile station 100 is present in the WiMAX network. With this, it is possible to identify that the mobile station 100 is present in the EV-DO network.

(Step S133) The HA 321 detects that the mobile station 100 has already been registered. In addition, the HA 321 requests the MN-HA key from the AAA server 322, and then validates the MIP registration, request using the MN-HA key received from the AAA server 322.

(Step S134) The HA 321 maintains the HoA which has already been assigned to the mobile station 100 and transmits a MIP registration response to the PDSN 222.

(Step S135) The PDSN 222 instructs the AAA server 322 to start charging for the mobile station 100 to use the wireless access network 220.

(Step S136) The PDSN 222 transmits a MIP registration response to the mobile station 100.

(Step S137) A data path is established between the mobile station 100 and the HA 321 via the PDSN 222. With this, packet data of the mobile station 100 is transmitted through the data path.

(Step S138) After the connection from the mobile station 100 to the wireless access network 220 (EV-DO system) is completed and the data path using the wireless access network 220 is thus established, the connection from the mobile station 100 to the wireless access network 230 (WiMAX system) is terminated.

(Step S139) The ASN gateway 232 instructs the AAA server 322 to stop charging for the mobile station 100 to use the wireless access network 230.

In this manner, it is possible to perform a handover from the wireless access network 230 to the wireless access network 220 while maintaining the IP address assigned to the mobile station 100.

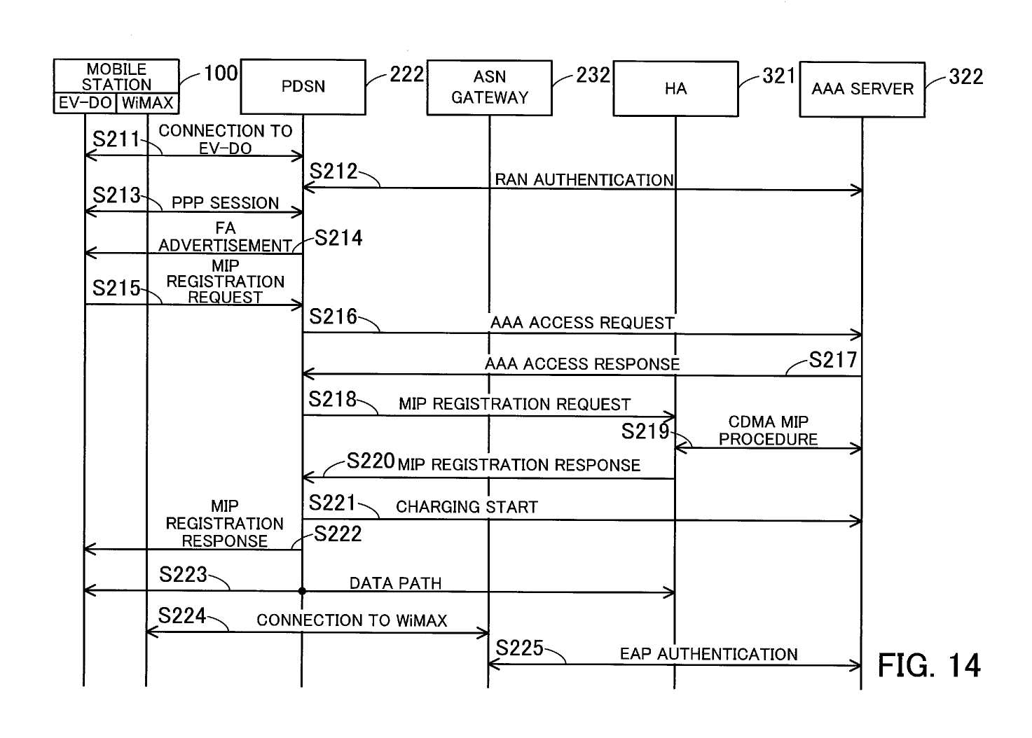

FIG. 14 is a sequence diagram illustrating an example of a second handover.

(Step S211) When entering into active mode from idle mode, the mobile station 100 is synchronized with the base station 221 and establishes connection with the PDSN 222 via the base station 221.

(Step S212) The PDSN 222 requests the AAA server 322 to authenticate the mobile station 100. Subsequently, the AAA server 322 performs RAN authentication.

(Step S213) The mobile station 100 establishes a PPP session with the PDSN 222 using PPP negotiation.

(Step S214) The PDSN 222 transmits a MIP message called a FA advertisement message to the mobile station 100.

(Step S215) The mobile station 100 transmits a MIP registration request to the PDSN 222. The MIP registration request includes the HoA of the mobile station 100 or the bit sequence having a bit length of 0 or 1.

(Step S216) The PDSN 222 accesses the AAA server 322. The AAA server 322 determines whether a home agent has already been designated to the mobile station 100. In this case, the HA 321 has been designated to the mobile station 100.

(Step S217) The AAA server 322 transmits, to the PDSN 222, an access response including information of the HA 321, which already been designated to the mobile station 100.

(Step S218) The PDSN 222 transmits a MIP registration request to the HA 321 designated by the AAA server 322. The MIP registration request does not include information indicating that the mobile station 100 is present in the WiMAX network. With this, it is possible to identify that the mobile station 100 is present in the EV-DO network.

(Step S219) The HA 321 detects that the mobile station 100 has already been registered. In addition, the HA 321 requests the MN-HA key from the AAA server 322, and then validates the MIP registration request using the MN-HA key received from the AAA server 322.

(Step S220) The HA 321 maintains the HoA which has already been assigned to the mobile station 100 and transmits a MIP registration response to the PDSN 222.

(Step S221) The PDSN 222 instructs the AAA server 322 to start charging for the mobile station 100 to use the wireless access network 220.

(Step S222) The PDSN 222 transmits a MIP registration response to the mobile station 100.

(Step S223) A data path is established between the mobile station 100 and the HA 321 via the PDSN 222. With this, packet data of the mobile station 100 is transmitted through the data path.

(Step S224) The mobile station 100 makes connection to the wireless access network 230.

(Step S225) The ASN gateway 232 requests the AAA server 322 to authenticate the mobile station 100. The AAA server 322 performs EAP authentication of the mobile station 100. In addition, the AAA server 322 designates the HA 321 to the mobile station 100.

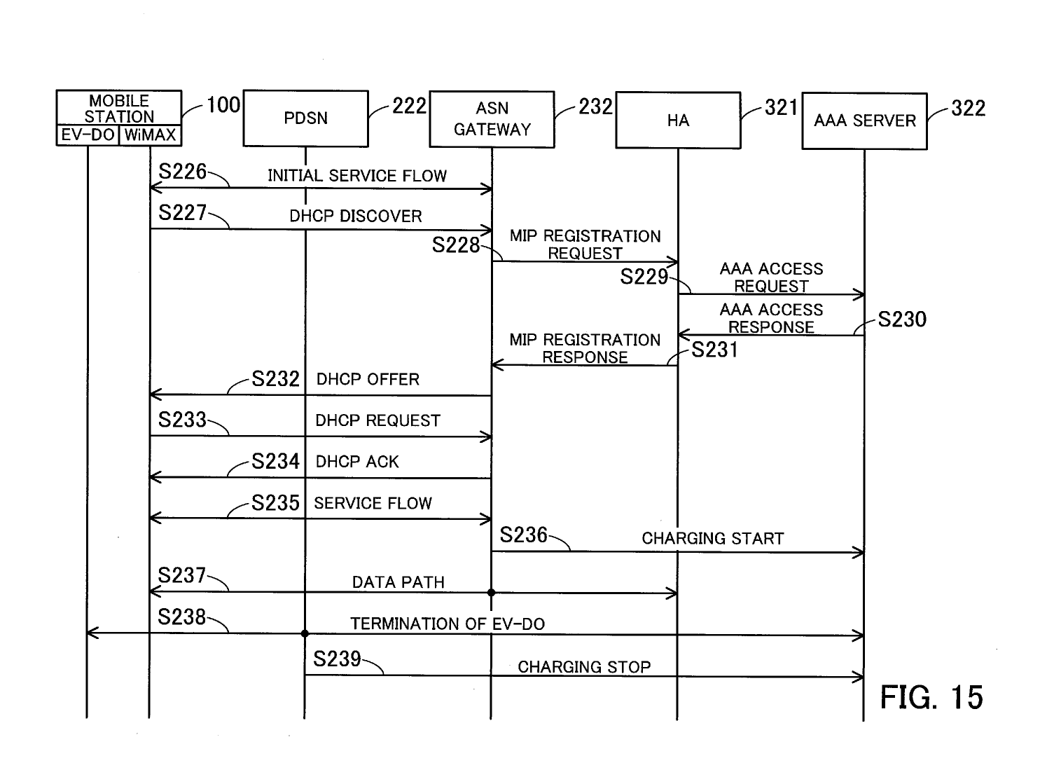

FIG. 15 is a sequence diagram illustrating the example of the second handover, continued from FIG. 14.

(Step S226) The ASN gateway 232 establishes an initial service flow with the mobile station 100 via the base station 231.

(Step S227) In order to acquire configuration information for communication using a DHCP, the mobile station 100 transmits a DHCP DISCOVER message to the ASN gateway 232.

(Step S228) The ASN gateway 232 transmits a MIP registration request to the HA 321 designated by the AAA server 322. The MIP registration request includes a PMIP access-technology type extension which is information indicating that the mobile station 100 is present in the WiMAX network.

(Step S229) The HA 321 requests a MN-HA key, which validates the MIP registration request, from the AAA server 322.

(Step S230) The AAA server 322 transmits the MN-HA key to the HA 321. The HA 321 validates the MIP registration request using the MN-HA key received from the AAA server 322.

(Step S231) The HA 321 maintains the HoA which has already been assigned to the mobile station 100 and transmits a MIP registration response to the ASN gateway 232.

(Step S232) The ASN gateway 232 transmits a DHCP OFFER message to the mobile station 100 via the base station 231.

(Step S233) The mobile station 100 transmits a DHCP REQUEST message to the ASN gateway 232 via the base station 231.

(Step S234) The ASN gateway 232 transmits a DHCP ACK message to the mobile station 100 via the base station 231.

(Step S235) The ASN gateway 232 establishes a service flow with the mobile station 100 via the base station 231.

(Step S236) The ASN gateway 232 instructs the AAA server 322 to start charging for the mobile station 100 to use the wireless access network 230.

(Step S237) A data path is established between the mobile station 100 and the HA 321 via the ASN gateway 232. With this, packet data of the mobile station 100 is transmitted through the data path.

(Step S238) After the connection from the mobile station 100 to the wireless access network 230 (WiMAX system) is completed and the data path using the wireless access network 230 is thus established, the connection from the mobile station 100 to the wireless access network 220 (EV-DO system) is terminated.

(Step S239) The PDSN 222 instructs the AAA server 322 to stop charging for the mobile station 100 to use the wireless access network 220.

In this manner, it is possible to perform a handover from the wireless network 220 to the wireless access network 230 while maintaining the IP address assigned to the mobile station 100. Note that although the mobile station 100 performs a MBBHO in the above description, the mobile station 100 may perform a break-before make handover (BBMHO) instead. In that case, in the handover from the wireless access network 230 to the wireless access network 220, the mobile station 100 establishes connection with the base station 221 after terminating connection with the base station 231. Similarly, in the handover from the wireless access network 220 to the wireless access network 230, the mobile station 100 establishes connection with the base station 231 after terminating connection with the base station 221.

According to the mobile communication system of the second embodiment, a handover to the wireless access network 220 having a large coverage area is performed even after packet communication in the wireless access network 230 having a small coverage area, and reception processing for the wireless access network 230 is subsequently stopped. Therefore, during idle mode, the mobile station does not have to receive paging information from the wireless access network 230 and search for a base station of the wireless network 230. That is, the mobile station 100 only needs to receive paging information from the wireless access network 220 and search for a base station of the wireless network 220 during idle mode, which results in a reduction in the power consumption of the mobile station 100 during idle mode. In addition, the mobile communication system according to the second embodiment is capable of preventing an increase in the workload of the mobile station 100 even if the timing of paging from the wireless access network 220 is the same as the timing of paging from the wireless access network 230.

In addition, after the idle mode is cancelled, the mobile station 100 performs a handover from the wireless access network 220 to the wireless access network 230 in order to perform packet communication. With this, the mobile station 100 is able to preferentially use the wireless access network 230 and therefore have the benefits of the wireless access network 230. Further, the handover between the wireless access networks 220 and 230, the mobile station 100 carries on the use of the same IP address, thereby being able to continuously receive IP services.

According to one embodiment, it is possible to reduce the power consumption of the mobile communication device during standby mode.

All examples and conditional language recited herein are intended for pedagogical purposes to aid the reader in understanding the invention and the concepts contributed by the inventor to furthering the art, and are to be construed as being without limitation such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. A mobile communication apparatus comprising:
a wireless communication unit configured to perform data communication using a first wireless access network and data communication using a second wireless access network having a larger coverage area than a coverage area of the first wireless access network; and
a control unit configured to perform a handover from the first wireless access network to the second wireless access network after the data communication using the first wireless access network is finished, and subsequently cause the mobile communication apparatus to enter into standby mode.

2. The mobile communication apparatus according to claim 1, wherein
the wireless communication unit refrains from searching for a base station of the first wireless access network during the standby mode.

3. The mobile communication apparatus according to claim 1, wherein
upon cancellation of the standby mode, the control unit performs a handover from the second wireless access network to the first wireless access network according to detection status of a base station of the first wireless access network.

4. The mobile communication apparatus according to claim 1, wherein
the control unit performs the handover from the first wireless access network to the second wireless access network in such a manner that use of an address assigned to the mobile communication apparatus before the handover is continued after the handover.

5. A wireless communication method for a mobile communication apparatus capable of handling a plurality of wireless access networks, the wireless communication method comprising:
performing data communication using a first wireless access network;
performing a handover from the first wireless access network to a second wireless access network having a larger coverage area than a coverage area of the first wireless access network after the data communication is finished; and
causing the mobile communication apparatus to enter into standby mode after the handover to second wireless access network.
